(19) United States
(12) Patent Application Publication
(10) Pub. No.: US 2003/0112463 A1
(43) Pub. Date: Jun. 19, 2003

(54) Path control method, a transmitter circuit, and a receiver circuit

(76) Inventor: Akihiko Kimoto, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/124,844

(22) Filed: Apr. 18, 2002

(30) Foreign Application Priority Data
Dec. 17, 2001 (JP) 2001-383726

(51) Int. Cl. B41J 1/00; G06F 15/00

(52) U.S. Cl. 358/1.15

(57) ABSTRACT

A virtual concatenation transmission offers a correct data transmission even when a failure occurs in some of virtual concatenation paths, which is realized by eliminating data from failing paths at multiplexing and restoring original data, and by eliminating failing paths from paths through which data is transmitted.

### BACKGROUND OF THE INVENTION

1. Field of the Invention

The present invention generally relates to a path controlling method, and a transmitter circuit and a receiver circuit thereof, and specifically relates to the path controlling method that performs a synchronous detection of data with a plurality of frame rates, and the transmitter circuit and the receiver circuit thereof.

2. Description of the Related Art

By the wide spread of the Internet, data communication capacity increases explosively, consequently bringing improvements in speed and economy of communication. It has become an old history when a user connected offices and sites located long distances apart with a small bandwidth. Recent concern is to hook up those remote locations with a large bandwidth economically and reliably.

Lately, especially in a trunk network, main stream of a synchronous network has been to use an interface such as SONET (Synchronous Optical Network) that is mainly used in North America, and SDH (Synchronous Digital Hierarchy) used by other countries. With the interface, cross connection and switching are performed in units of VC-3 (Virtual Container 3) of about 50 Mbit/s capacity, and VC-4 of about 150 Mbit/s capacity.

When a bandwidth wider than 150 Mbit/s capacity is required, a VC-4-4c (about 600 Mbit/s capacity) path, and a VC-4-16c (about 2.4 Gbit/s capacity) path are available, which are configured by concatenating a plurality of VC-4 paths. While trunk switches compliant with VC-3 and VC-4 are commercially available, not many choices are available for trunk switches compliant with the VC4-4c or the VC-4-16c paths. Accordingly, a method called a virtual concatenation is considered as a vehicle to offer a wide bandwidth, using readily available products effectively.

FIG. 1 shows a format of VC-4-Xc. The format includes 9 bytes of POH (Path Overhead) located in a head part, followed by 9×(X-1) stuff bytes and 9xXx260 bytes of a container C-4-Xc. Contents of the POH are shown in FIG. 2.

A virtual concatenation can be configured by VC-3 paths, VC-2 paths and VC-11 paths. Hereafter, explanations will be given around a virtual concatenation of VC-4 paths.

FIG. 3 shows how original data in a container C-4-Xc, capacity of which is Xx149760 kbit/s, is divided into X VC-4 paths. Here, the data to be transmitted in the container C-4-Xc is stuffed into X VC-4 paths on a byte-by-byte basis. That is, byte interleave is performed.

The X VC-4 paths are routed through not necessarily the same route, therefore, data on different paths will likely arrive at a receiving point with different delays, making it difficult to determine a sequence of original data. Then, an H4 byte of the POH is used in order to transmit a stuffing sequence (Sequence indicator: SQ) and a data phase (Multi-frame indicator: MFI) that are coded. FIG. 4 shows how the SQ and the MFI are coded into the H4 byte. FIG. 5 shows how the SQ and the MFI are inserted in each frame.

Thereby, at the receiving point, the data phase (MFI) of each VC-4 path is aligned, and the original data of the container C-4-Xc is reproduced by multiplexing on a byte-by-byte basis according to the sequence (SQ).

FIG. 5 and FIG. 6 show block diagrams of an example of a conventional transmitting circuit and a conventional receiving circuit, respectively, of a transmission apparatus. In this example, an eight-path virtual concatenation is employed to transmit and receive Gigabit Ethernet (GbE) data.

In the transmitting circuit of FIG. 6, a clock is changed by the GbE termination unit 10 from a clock of a LAN to a clock of the transmission apparatus, and data transmission is suspended such that a portion for inserting POH etc. is vacated based on a signal from a timing generating unit 12. An MF counter unit 14 generates multi-frame information MFI, based on the signal from the timing generating unit 12, which is provided to an POH adding units 16a through 16h. A ⅛ dividing unit 18 receives the data from the GbE terminating unit 10, and transmits the data to the POH adding units 16a through 16h on a byte-by-byte basis by control from the timing generating unit 12.

At the POH adding units 16a through 16h, POH is inserted in each path based on a timing signal from the timing generating unit 12. In this case, multi-frame information from the MF counter unit 14 and each sequence (SQ) are inserted in the H4 byte. Pointer adding units 20a through 20h add a pointer that indicates a head position of each path as a part of an SOH (Section OverHead), which is supplied from the POH adding units 16a through 16h, according to the timing from the timing generating unit 12.

In the receiving circuit of FIG. 7, pointer detecting units 30a through 30h detect the pointer of each path, and detected timing is provided to each of RDIDET units, REIDET units, B3DET units, and MF synchronizing units. In addition, detection of an AIS (Alarm Indication Signal) and LOP (Loss Of Pointer) is also performed simultaneously.

The RDIDET units 31a through 31h detect an RDI signal that indicates a result of a path error supervision B3 of a counterpart station, the RDI signal being included in a G1 byte of the POH, as shown in FIG. 2. The REIDET units 32a through 32h detect an REI signal that indicates a result of a path failure detection of the counterpart station, the REI signal being included in the G1 byte of the POH, as shown in FIG. 2. The B3DET units 33a through 33h detect an error based on a B3 byte of the POH.

In the MF synchronizing units 34a through 34h, while taking multi-frame synchronization of the H4 byte of the POH based on the timing from the pointer detecting units 30a through 30h, the SQ information is extracted. Further, writing control of the phase matching memory unit 35a through 35h is performed based on the multi-frame information, and the multi-frame information and the SQ information are provided to a reading control unit 36.

In the reading control unit 36, a reading phase of the phase matching memory unit 35a through 35h and a sequence of reading are determined from the multi-frame information MFI and the SQ information from each of the MF synchronizing units 34a through 34h such that reading control of the phase matching memory unit 35a through 35h and control of an 8/1 multiplexing unit 38 are performed. In the GbE terminating unit 40, the clock is changed from the clock of the transmission apparatus to the clock of the LAN.

In conventional virtual concatenation, transmission data is divided into a plurality of paths in a fixed manner. For this reason, if there is a failure in one of the paths, the data cannot be restored altogether.

This is because the transmitted data is divided on a byte-by-byte basis, assigned to a predetermined fixed path, and is multiplexed on a byte-by-byte basis by a receiving end in a fixed manner.

Where most of data sent and received is LAN data and Internet data, the virtual concatenation method requires all of assigned bandwidth at a peak period. It is a problem that a failure in on of the paths damages all the data transmission.

### SUMMARY OF THE INVENTION

Accordingly, it is a general object of the present invention to provide a path control method, a transmitter circuit and a receiver circuit that obviate one or more of the problems caused by the limitations and disadvantages of the related art.

It is another and more specific object of the present invention to provide a path control method, a transmitter circuit and a receiver circuit that achieve a successful communication of data that may include a plurality of multi-framing rates, even though a failure occurs in a part of virtual concatenation paths.

In order to achieve the above objects according to the present invention, the path control method includes removing a failing path from assigning data to be transmitted, which is realized by the receiver circuit including a first failure detection unit and a data restoration unit that use only data from normally operating paths, excepting the failing path, and by the transmitter circuit including a second failure detection unit and a data assignment control unit that assigns data only to normally operating paths.

Other objects and further features of the present invention will be apparent from the following detailed description when read in conjunction with the accompanying drawings.

### BRIEF DESCRIPTION OF THE DRAWINGS

FIG. 1 is a figure showing a format of VC-4-Xc;

FIG. 2 is a figure showing contents of POH;

FIG. 3 is a figure showing how data of a container C-4-Xc is divided into X VC-4 paths;

FIG. 4 is a figure showing how SQ and MFI are coded to an H4 byte;

FIG. 5 is a figure showing how SQ and MFI are inserted in each frame;

FIG. 6 is a block diagram of an example of a transmitter circuit of a conventional transmission apparatus;

FIG. 7 is a block diagram of an example of a receiving circuit of a conventional transmission apparatus;

FIG. 8 is a block diagram of an embodiment of the transmitting circuit of a transmission apparatus to which a path control method of the present invention is applied;

FIG. 9 is a signal timing chart of a writing ENV (enable) signal, a writing data signal, a reading ENV (enable) signal, and a reading data signal supplied to a buffer memory unit in normal operation;

FIG. 10 a signal timing chart of a writing ENV (enable) signal, a writing data signal, a reading ENV (enable) signal, and a reading data signal supplied to the buffer memory unit when a failure is detected by a receiver circuit of a counterpart transmission apparatus;

FIG. 11 is a block diagram of a first embodiment of a receiving circuit of the transmission apparatus to which the path control method of the present invention is applied;

FIG. 12 is a signal timing chart of a writing ENV (enable) signal, a writing data signal, a reading ENV (enable) signal, and a reading data signal supplied to a buffer memory unit when a failure is detected;

FIG. 13 is a block diagram of a second embodiment of the receiving circuit of the transmission apparatus to which the path control method of the present invention is applied;

FIG. 14 is a figure showing an example of how normal and failing statuses are set up by 8 bits, corresponding to eight paths, of an F2 byte by “1” and “0”, respectively; and

FIG. 15 is a figure showing an example of providing SQ failure information in hexadecimal notation using the F2 byte of the POH.

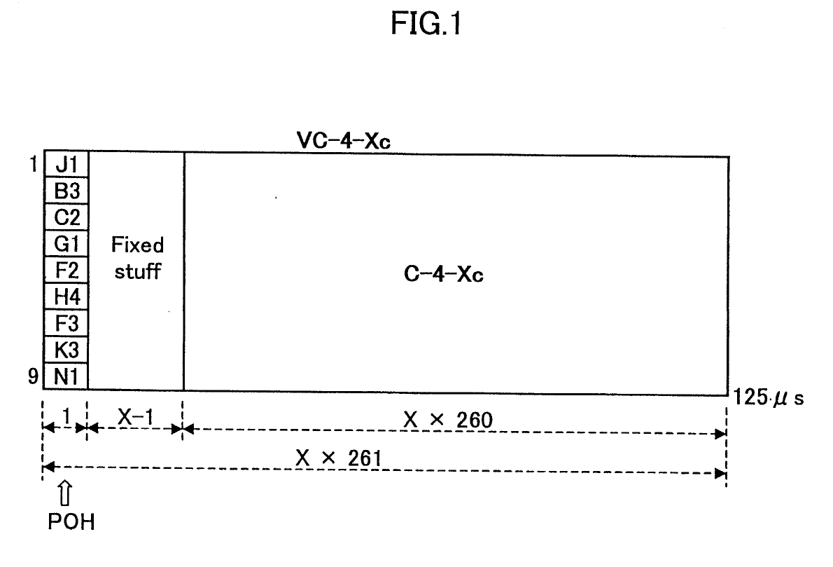

### DESCRIPTION OF THE PREFERRED EMBODIMENTS

In the following, embodiments of the present invention will be described with reference to the accompanying drawings.

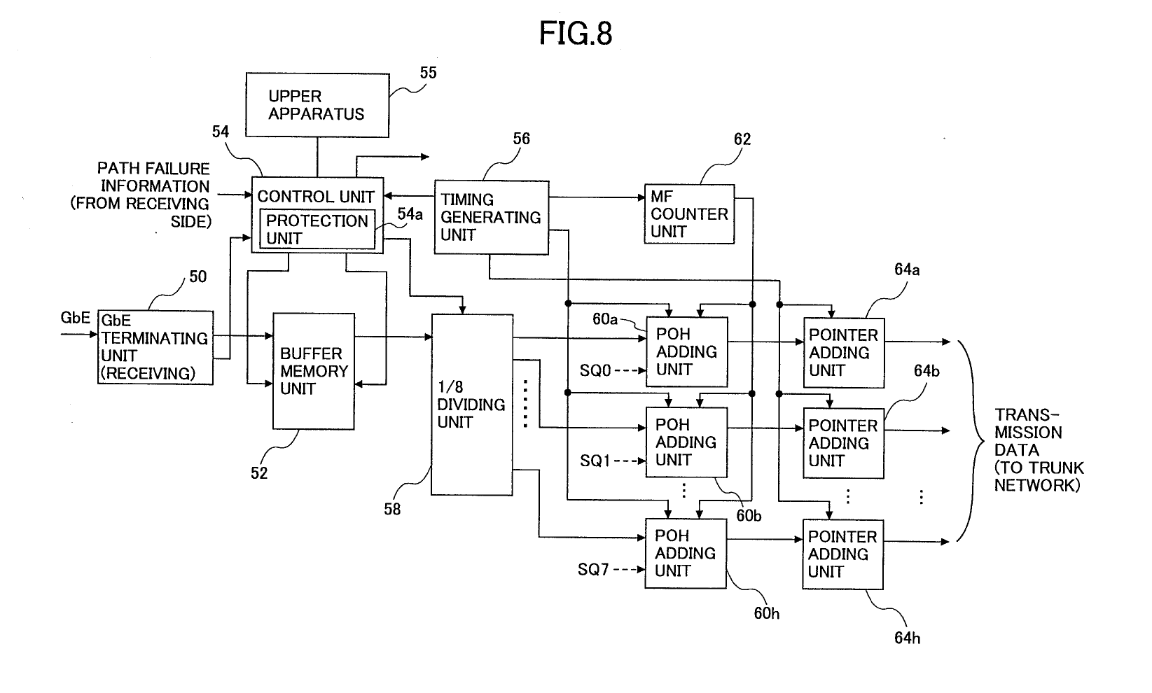

FIG. 8 shows a block diagram of an embodiment of a transmitting circuit of a transmission apparatus to which a path control method of the present invention is applied. In the present embodiment, Gigabit Ethernet (GbE) data is transmitted and received through a virtual concatenation employing eight paths.

The transmitting circuit includes a GbE terminating unit 50, a buffer memory unit 52, a control unit 54, a protection unit 54a, an upper apparatus 55, a timing generating unit 56, an ⅛ dividing unit 58, a plurality of POH adding units 60a through 60h, an MF counter unit 62, and a plurality of pointer adding units 64a through 64h.

The GbE terminating unit 50 changes clock from a clock of a LAN to a clock of the transmission apparatus, receives data, and provides the data to the buffer memory unit 52. Further, when an opening (idle) occurs to the data supplied from the LAN, that is, vacant data, information that the data iv vacant is provided to the control unit 54. Then, the control unit 54 controls such that no more than a predetermined amount of vacant data is written in the buffer memory unit 52.

The control unit 54 stores a writing phase (address) at which writing of the vacant data to the buffer memory unit 52 is stopped concerning the data from the GbE terminating unit 50, which changed from valid data to the vacant data. The control unit 54 further controls such that sequential reading based on the timing generating unit 56 is performed, until a reading phase (address) catches up with the writing phase (address). The control unit 54 also controls the ⅛ dividing unit 58 such that data is sequentially provided to the POH adding units 60a through 60h on a byte-by-byte basis.

The POH adding units 60a through 60h insert POH to each path according to timing from the timing generating unit 56. At this point, multi-frame information from the MF counter unit 62 and each sequence (SQ) are inserted in the H4 byte. The pointer adding units 64a through 64h add a pointer to SOH of each path, the pointer indicating a head position, and the SOH being supplied from the POH adding units 60a through 60h according to the timing from the timing generating unit 56.

Here, the above operations are based on the timing from the timing generating unit 56. This is in order to make openings for inserting information such as a POH, and to align change timing (a byte break) of the ⅛ dividing unit.

Suppose that a first transmission apparatus and a second transmission apparatus are in communication. Each transmission apparatus includes a transmitting circuit and a receiving circuit, as a pair. When a failure is detected by the receiving circuit of the second transmission apparatus, path failure information, such as RDI, REI, and B3, is supplied to the control unit 54 of the first transmission apparatus from an apparatus control unit 90 (to be described later) of the receiving circuit of the first transmission apparatus.

RDI, REI, and B3 signals received by the receiving circuit of the first transmission apparatus are transmitted from the second transmission apparatus, reporting a status of an error detected by the second transmission apparatus.

When an error rate indicated by any of the RDI, REI, and B3 signals exceeds a threshold value (a second threshold value), the control unit 50 determines that there is a failure in the path, and controls the path concerned such that reading from buffer memory unit 52 is stopped, as a result, stopping assignment of data to the failing path.

The protection unit 54a in the control unit 54 stores a value that is compared with the number of times of protection taking place for each path. When the number of failure events and recovery events therefrom of a path exceeds the value, the control unit 54 determines that the path is failing and recovered, respectively. The second threshold value and the value relative to the number of times of protection can be changed from the upper apparatus 55, such as a supervisory unit.

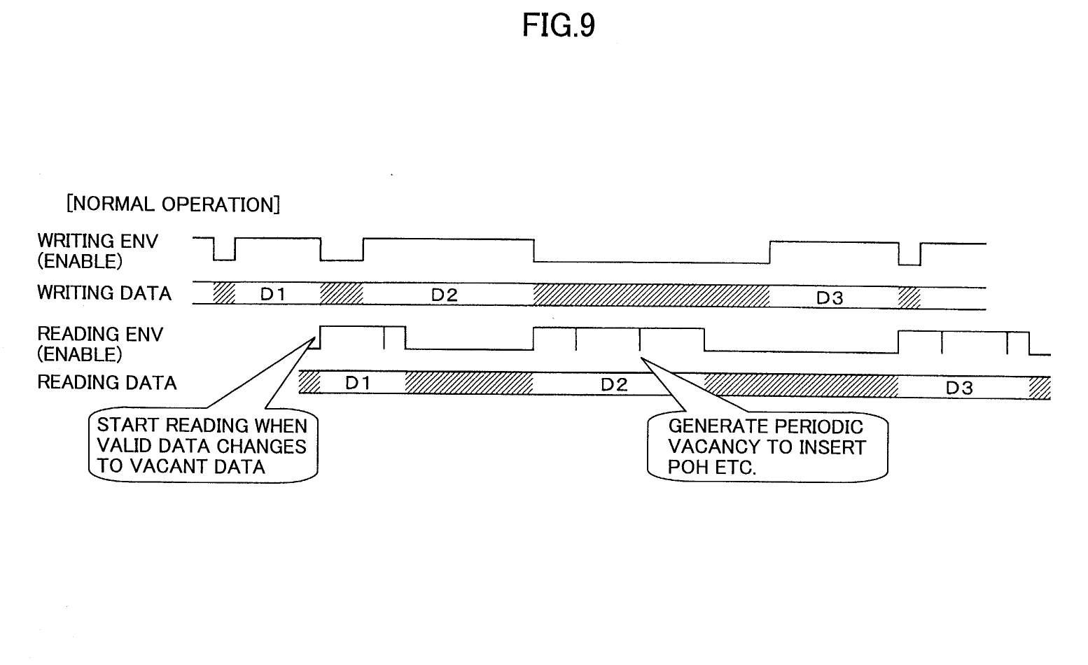

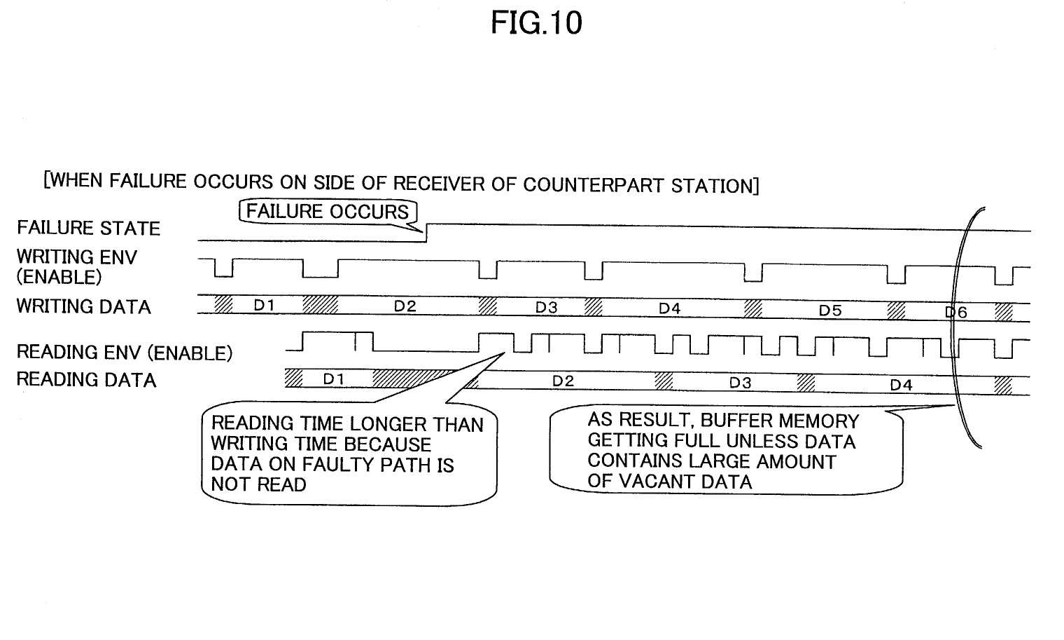

FIG. 9 shows a signal timing chart of a writing ENV (enable) signal, a writing data signal, a reading ENV (enable) signal, and a reading data signal supplied to the buffer memory unit 52 under normal operation. FIG. 10 shows a signal timing chart of the writing ENV (enable) signal, the writing data signal, the reading ENV (enable) signal, and the reading data signal supplied to the buffer memory unit 52 when a failure is detected by the receiving circuit of the second transmission apparatus.

When data with a small amount of vacant data is inputted continuously, a writing phase (address) catches up with a reading phase (address), that is, a buffer-full state occurs. When such a situation occurs, the control unit 54 stops writing to the buffer memory unit 52, until the buffer memory unit 52 regains a predetermined capacity available.

However, frames at the time of stopping writing, and at the time of resuming will become invalid. In order to avoid this, writing is stopped when the writing phase and the reading phase are apart by less than a predetermined amount α, and until the two phases become apart by more than β, which is greater than α. When the two are apart by greater than β, the writing is resumed. In this manner, frames at stopping writing and resuming are saved intact.

However, stopping writing due to the buffer being full causes data to be discarded. It is, therefore, fundamentally necessary to control such that the buffer will not become full. In order to achieve this, the control unit 54 transmits to the LAN through the apparatus control unit 90 (to be described later) a pause signal (in the case of a full duplex), a back pressure (in the case of a half duplex), etc. such that data transmission is stopped, when the writing phase (address) approaches a reading phase (address) closer than a predetermined amount α.

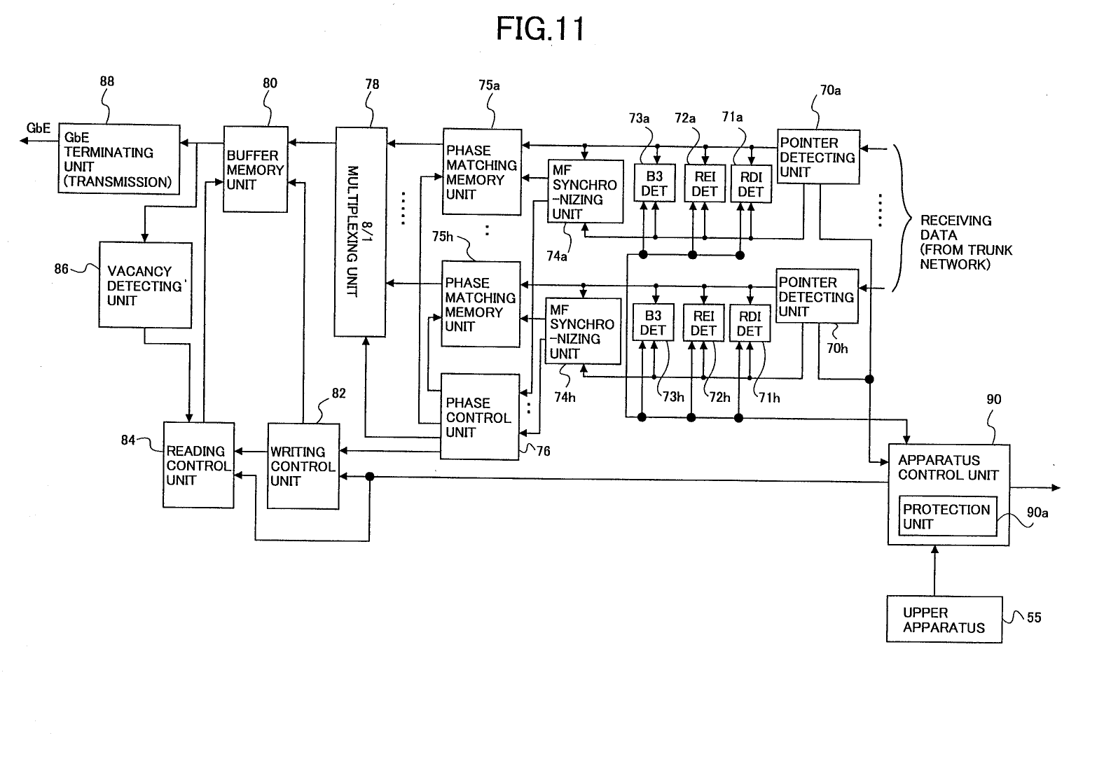

FIG. 11 shows a block diagram of a first embodiment of the receiving circuit of the transmission apparatus to which the path control method of the present invention is applied.

The receiving circuit includes pointer detecting units 70a through 70h, RDIDET units 71a through 71h, REIDET units 72a through 72h, B3DET units 73a through 73h, MF synchronizing units 74a through 74h, phase matching memory units 75a through 75h, a phase control unit 76, an 8/1 multiplexing unit 78, a buffer memory unit 80, a writing control unit 82, a reading control unit 84, a vacancy detecting unit 86, a GbE terminating unit (transmission) 88, an apparatus control unit 90, a protection unit 90a, and an upper apparatus 55.

The pointer detecting units 70a through 70h detect a pointer of each path, and timing of the detected pointer is provided to each of the RDIDET, REIDET, B3DET, and MF synchronizing units. Failure detection of AIS and LOP is simultaneously carried out, and result of the failure detection is provided to the writing control unit 82, the reading control unit 84, and the apparatus control unit 90.

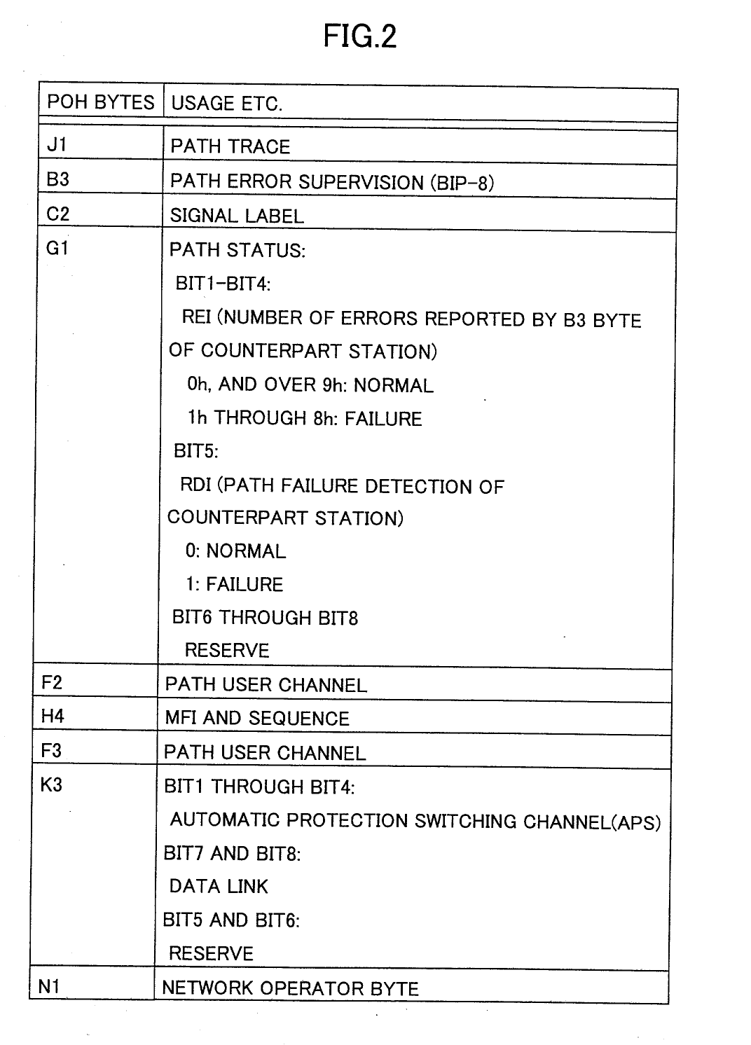

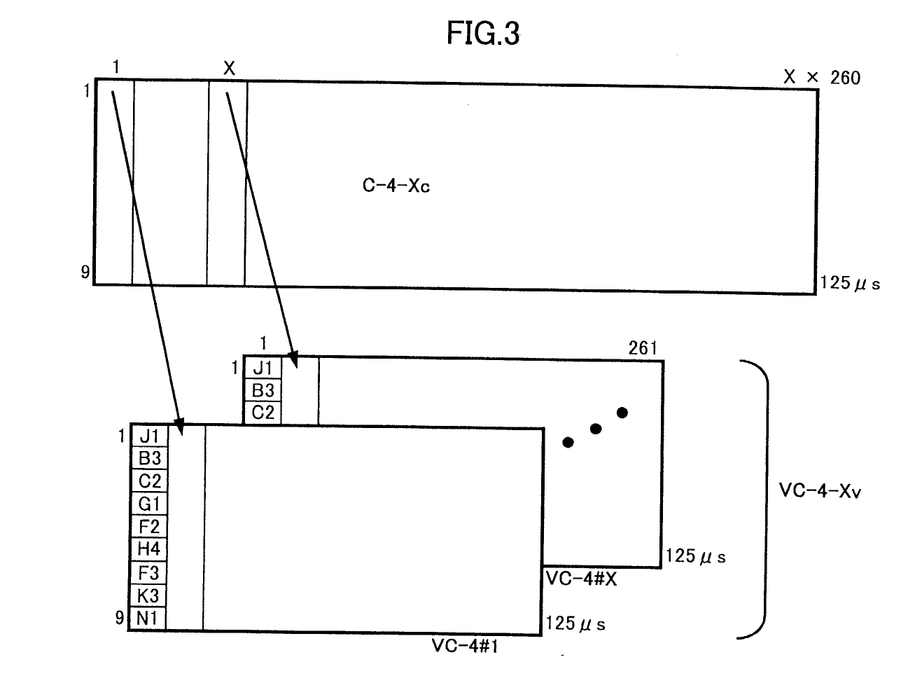

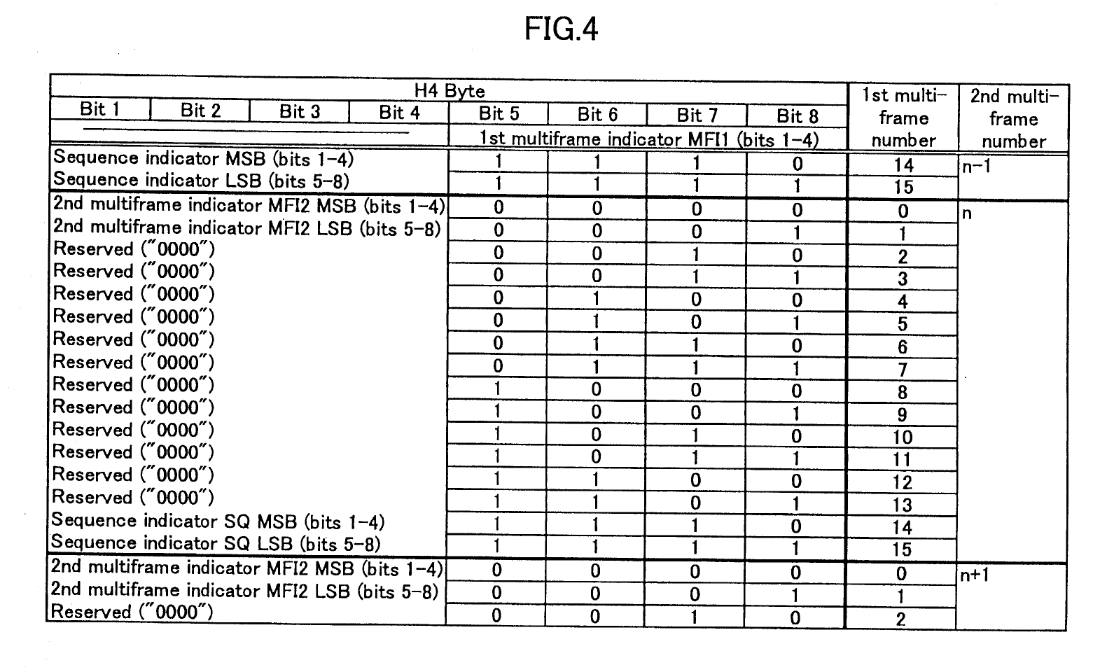

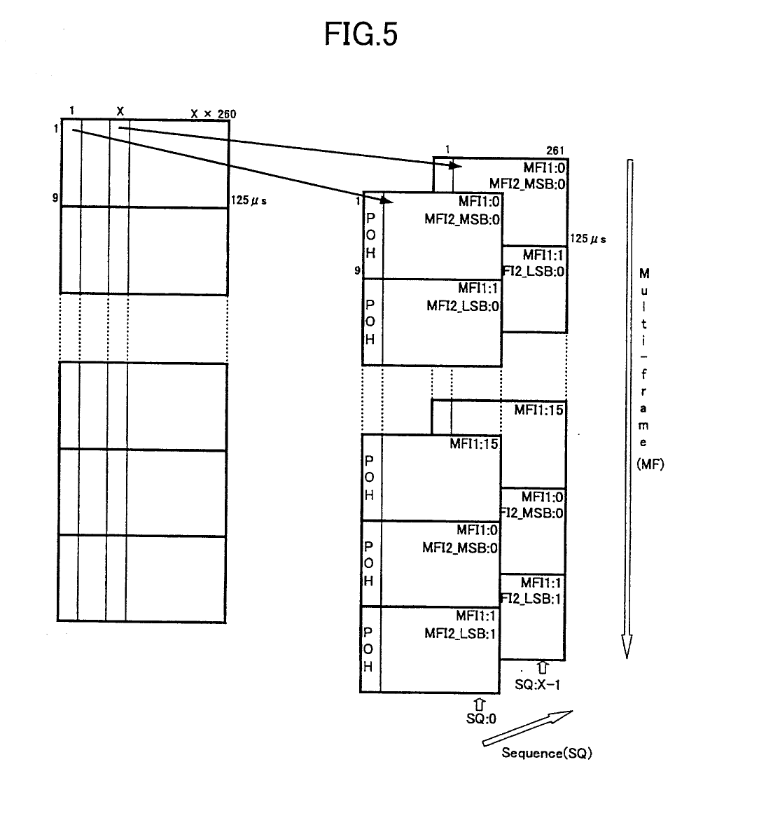

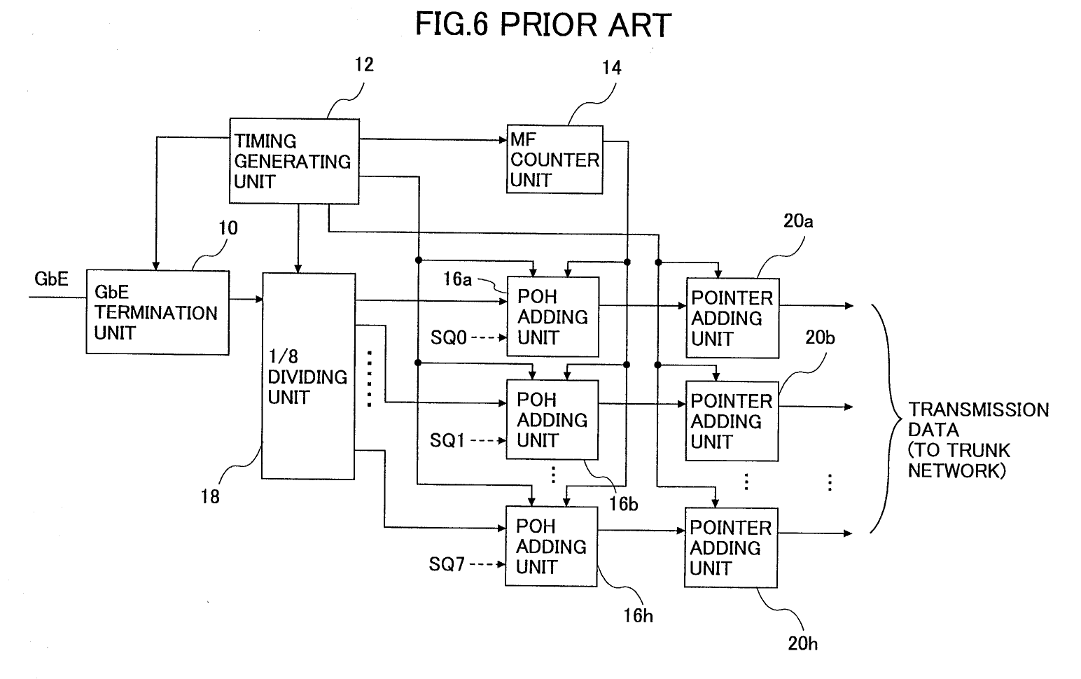

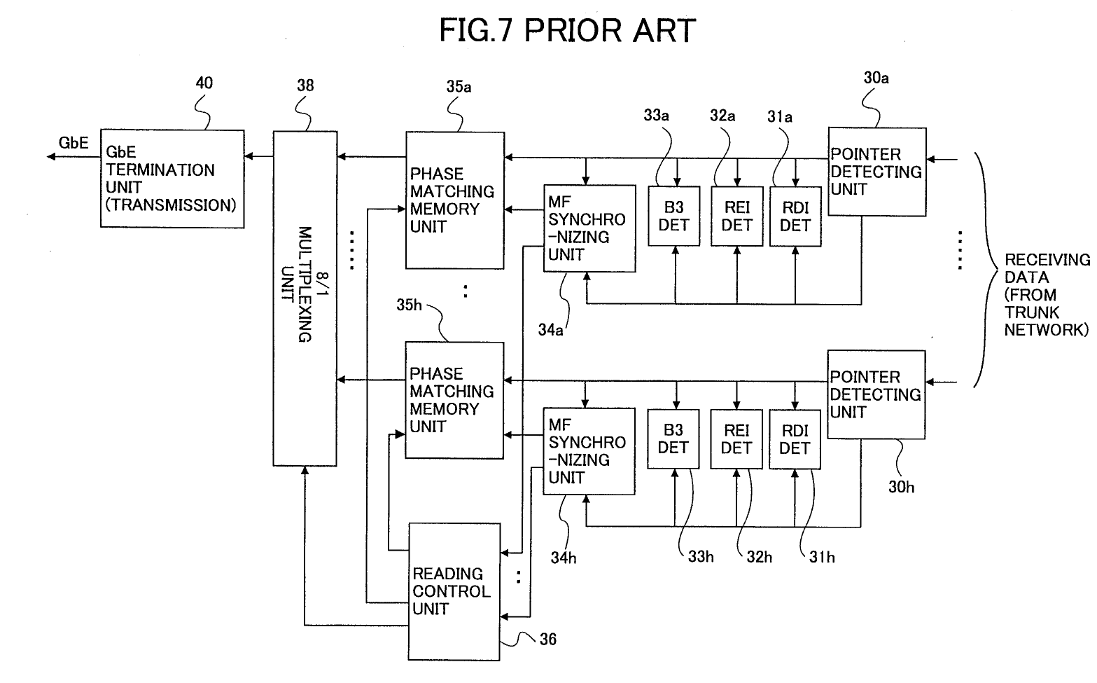

The RDIDET units 71a through 71h detect RDI, which is a B3 error result of a counterpart station, stored in the G1 byte of the POH, as shown in FIG. 2. The REIDET units 72a through 72h detect REI, which indicates a result of a path failure detection of the counterpart station, stored in the G1 byte of the POH, as shown in FIG. 2. The B3DET units 73a through 73h perform error detection by the B3 byte of the POH. Detected signals from the above REIDET units 71a through 71h, REIDET 72a through 72h units and B3DET units 73a through 73h are supplied to the apparatus control unit 90

In the MF synchronizing units 74a through 74h, a multi-frame synchronization of the H4 byte of the POH is carried out based on the timing from the pointer detecting units 70a through 70h, and the SQ information is extracted. Then, writing control of the phase matching memory units 75a through 75h is performed based on multi-frame information. Further, the multi-frame information and SQ information are provided to the phase control unit 76.

The phase control unit 76 determines the reading phase of the phase matching memory units 75a through 75h, and a reading sequence based on the multi-frame information MFI and the SQ information provided by the MF synchronizing units 34a through 34h, controls reading of the phase matching memory units 75a through 75h, and controls the 8/1 multiplexing unit 78.

The writing control unit 82 controls such that data from a failing path is not written to the buffer memory unit 80, based on a failure situation of each path determined by information as to which path is being read from the phase control unit 76, and failure situation information supplied from the apparatus control unit 90.

The vacancy detecting unit 86 detects when a data stream changes from valid data to vacant data, and the change timing point is provided to the reading control unit 84.

Then, the reading control unit 84 compares the writing phase (address) provided from the writing control unit 82 with a reading phase (address) generated by the reading control unit 84. Where the two phases are apart by an amount that is greater than a predetermined amount, reading is continued. Otherwise, the reading is suspended until the two phases become apart by an amount greater than a predetermined amount. When a failure occur in two or more paths, the apparatus control unit 90 directs the reading control unit 84 to increase a value of the predetermined amount, such that data dropping is prevented. In the GbE terminating unit 88, clock is changed from a clock of the transmission apparatus to a clock of the LAN.

The apparatus control unit 90 controls such that the writing control unit 82 does not write data from a failing path to the buffer memory unit 80, based on failure situation of each path provided by the pointer detecting units 70a through 70h. Moreover, when an error rate of each path obtained from RDI, REI, and B3 exceeds a threshold (a first threshold), the path concerned is determined failing and the writing control unit 82 is directed such that data is not written to the buffer memory unit 80.

In addition, the a value that is compared with the number of times of protection taking place for each path is set up in the protection unit 90a in the apparatus control unit 90 for every path. When the number of failures, and recoveries from the failures exceeds the above-mentioned value relative to the number of times of protection, the apparatus control unit 90 determines that the path is failing, and has recovered from a failure, respectively. The value relative to the number of times of protection can be changed by the upper apparatus 55, such as a supervisory unit.

The apparatus control unit 90 transmits a pause signal, a back pressure, etc. such that data transmission from the LAN is suspended, when a buffer-full status is to be avoided by the control unit 54 based on path failure information such as RDI, REI, and B3 provided to the control unit 54 of the transmitting circuit.

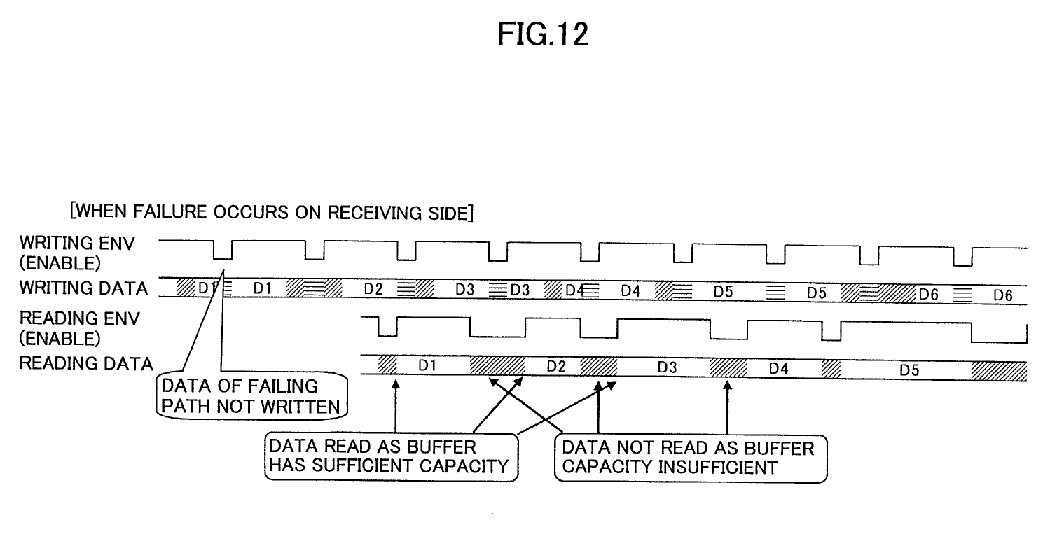

FIG. 12 shows a signal timing chart of a writing ENV (enable) signal, a writing data signal, a reading ENV (enable) signal, and a reading data signal supplied to the buffer memory unit 80 when a failure is detected. By performing control such as this, only data from normal paths is multiplexed, realizing data restoration.

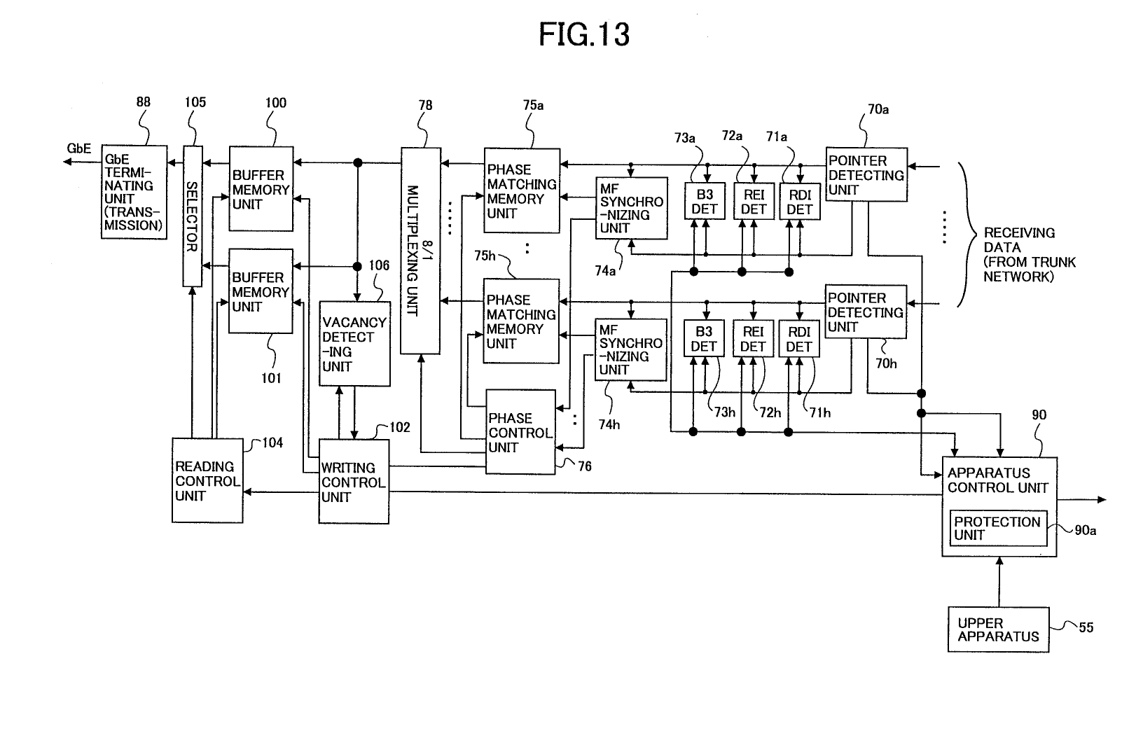

FIG. 13 shows a block diagram of a second embodiment of the receiving circuit of the transmission apparatus to which the path control method of the present invention is applied. In FIG. 13, the same reference sign is given to the same unit as FIG. 11.

The receiving circuit includes pointer detecting units 70a through 70h, RDIDET units 71a through 71h, REIDET units 72a through 72h, B3DET units 73a through 73h, MF synchronizing units 74a through 74h, phase matching memory units 75a through 75h, a phase control unit 76, an 8/1 multiplexing unit 78, a GbE terminating unit (transmission) 88, an apparatus control unit 90, a protection unit 90a, buffer memory units 100 and 101, a writing control unit 102, a reading control unit 104, a selector SEL 105, a vacancy detecting unit 106, and an upper apparatus 55.

In FIG. 13, the pointer detecting units 70a through 70h detect a pointer of each path, and timing of the detected pointer is provided to each of the RDIDET units, the REIDET units, the B3DET units, and the MF synchronizing units. Detection of AIS or LOP is carried out simultaneously, and result of the detection is provided to the writing control unit 102, the reading control unit 104, and the apparatus control unit 90.

The RDIDET units 71a through 71h detect RDI, which is a B3 error result of a counterpart station, and stored in the G1 byte of the POH, as shown in FIG. 2. The REIDET units 72a through 72h detect REI, which is a result of a path failure detection of the counterpart station, and stored in the G1 byte of the POH, as shown in FIG. 2. The B3DET units 73a through 73h perform error detection by the B3 byte of the POH. Detected signals of the above RDIDET units 71a through 71h, the REIDET units 72a through 72h and the B3DET units 73a through 73h are supplied to the apparatus control unit 90.

The MF synchronizing units 74a through 74h take the multi-frame synchronization of the H4 byte of the POH byte by the timing from the pointer detecting units 70a through 70h, and extract the SQ information. Further, writing control of the phase matching memory unit 75a through 75h is performed based on multi-frame information. The multi-frame information and the SQ information are provided to the phase control unit 76.

The phase control unit 76 determines a reading phase of the phase matching memory units 75a through 75h, and a reading sequence from the multi-frame information MFI and the SQ information from the MF synchronizing units 34a through 34h, controls reading of the phase matching memory unit 75a through 75h, and controls the 8/1 multiplexing unit 78.

The writing control unit 102 provides detected timing to the vacancy detecting unit 106 so that data from a failing path may not be erroneously detected as vacancy data, based on information from the phase control unit 76 as to which path is being read, and a failure situation of each path supplied from the apparatus control unit 90. The vacancy detecting unit 106 detects vacancy data based on this timing, and provides a detection result to the writing control unit 102.

The apparatus control unit 90 controls such that the writing control unit 102 does not write data from a failing path to the buffer memory unit, based on information relative to the failure situation of each path from the pointer detecting units 70a through 70h. Moreover, when an error rate of a path, which is indicated by any of RDI, REI, and B3 exceeds a threshold (a first threshold), the path concerned is determined to be failing, and the writing control unit 102 is directed not to write data from the failing path to the buffer memory unit.

In addition, the a value that is compared with the number of times of protection taking place for each path is set up in the protection unit 90a in the apparatus control unit 90 for every path. When the number of failures and recoveries from the failures exceeds the value relative to the number of times of protection, the apparatus control unit 90 determines that the path is failing and has recovered from a failure, respectively. The value relative to the number of times of protection can be changed by the upper apparatus 55, such as a supervisory unit.

When the vacancy detecting unit 106 detects that data changed from valid data to vacant data, the writing control unit 102 switches a buffer memory unit from a first buffer memory unit that is one of the buffer memory units 100 and 101 to a second buffer memory unit that is the other buffer memory unit, such that the second buffer memory unit will be used when valid data resumes later. When writing is completed, an identification of the buffer memory unit to which the data is written, and amount of the data (address, in fact) are supplied to the reading control unit 104.

The reading control unit 104 stores information from the writing control unit 102 temporarily until second next information is supplied. According to the information, reading from the buffer memory units 100 and 101, and switching by the selector 105 are controlled.

A purpose of the reading control unit 104 storing the information from the writing control unit 102 temporarily is as follows. For example, when a small amount of data is written to the buffer memory unit 101 after having written a large amount of data to the buffer memory unit 100, a next writing shall be to the buffer memory unit 100, while reading from the same buffer memory unit 100 continues. In this case, the information (buffer memory unit identification and data volume) stored is used such that data first written is sequentially read.

In this embodiment, as compared with the first embodiment, control of reading and writing of the buffer memory units 100 and 101 is easier, and the buffer memory units 100 and 101 can be configured by simply structured components such as a FIFO.

Moreover, when a transmission apparatus A and a transmission apparatus B are communicating, the method of multiplexing and restoring data when a failure is present can be performed as follows. When the receiving circuit of the transmission apparatus A detects a failure, valid path information (i.e., identifications of valid paths) is provided from the transmitting circuit of the apparatus A to the receiving circuit of the apparatus B. The receiving circuit of the apparatus B uses the information such that only data from valid paths is used to restore the data.

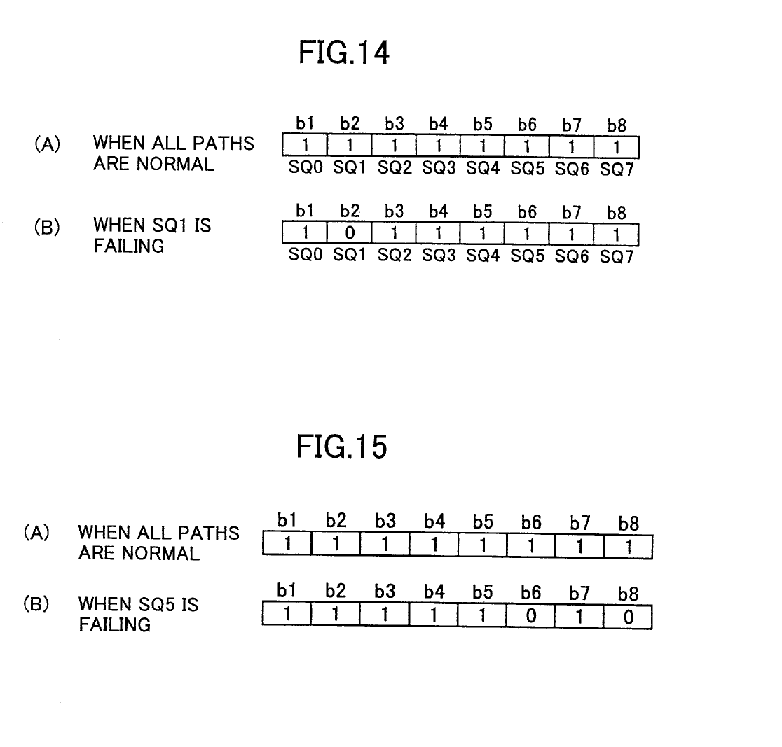

Suppose that the communication is performed in an 8-path virtual concatenation, wherein a specific byte of the POH, for example, an F2 byte is used to carry the valid path information. In this case, as shown in FIG. 14, each of eight bits of the F2 byte indicates one of valid status (for example, “1”) and invalid (“0”) status of each path. The F2 byte of all the eight paths are arranged in this manner, and transmitted. At (A) of FIG. 14, the case where all paths are normal is shown, and at (B) of FIG. 14, the case where a path identified as SQ1 is invalid, i.e., failing.

When a failure is detected by the receiving circuit of the transmission apparatus A, the fact is supplied to the control unit 54 of the transmitting circuit from the apparatus control unit 90 of the receiving circuit, such that the control unit 54 controls the POH adding units 60a through 60h, and valid path information is supplied from the transmission apparatus A to the transmission apparatus B.

At the transmission apparatus B, the F2 byte of each path is extracted by the MF synchronizing units 74a through 74h of the receiving circuit. Then, in the phase control unit 76, a majority judging is carried out (since one of the 8 paths is failing, in this case, the same F2 byte received by 4 or more paths is considered correct), and data of paths that are determined valid is multiplexed to restore data.

When more than eight paths are used in a virtual concatenation, for example, 16 paths and 64 paths, SQ of a failing path is expressed in hexadecimal, using the F2 byte of the POH, as shown in FIG. 15. At (A) of FIG. 15, the case where all paths are normal is shown, and at (B) of FIG. 15, the case where a path identified as SQ5 is failing. However, by this method, although it is effective in indicating a failure of only one path, when failure occurs simultaneously at two or more paths, additional bytes are needed.

In the H4 byte used for transmission and reception of multi-frame information in the virtual concatenation method, 48 reserve bits are available. The valid path information may be transmitted using these reserve bits. Moreover, since the H4 byte has a multi-frame configuration, a path capacity change can be smoothly performed. For example, an arrangement can be prepared between the transmission apparatus A and the transmission apparatus B such that contents inserted to MFI=2 through 13 shall be applicable to frames starting from a next frame of MFI=0, ensuring correct timing of the path capacity change.

If a configuration is such that the valid path information can be set up by the upper apparatus 55, as shown in FIG. 8, data transmission can be performed using paths designated by the upper apparatus 55. This ability of the upper apparatus 55 is useful when a specific path has to be put out of service manually for repair, replacement, adjustment and the like.

Although the embodiments have been explained around SDH, the embodiment can apply to SONET. The present invention is not limited to the embodiments described above as examples.

Relationships between the units in the above description and the units described in the claims hereunder are as follows.

The pointer detecting units 70a through 70h, the RDIDET units 71a through 71h, the REIDET units 72a through 72h, and the B3DET units 73a through 73h correspond to the first and the second failure detecting units. The phase control unit 76 and the apparatus control unit 90 correspond to the data restoration unit, and the control unit 54 corresponds to the allocation control unit. The protection unit 90a corresponds to the first protection unit, and the protection unit 54a corresponds to the second protection unit. The upper apparatus 55 corresponds to the first setting up unit, the second setting up unit, and the time difference setting up unit. The apparatus control unit 90 corresponds to the reporting unit, the buffer memory unit 52 corresponds to the first storing unit, and the control unit 54 corresponds to the supply halt reporting unit. The buffer memory units 100 and 101 correspond to the second storing units, and the writing control unit 102 corresponds to the switching unit.

As above, the present invention provides a path controlling method, a transmitter circuit and a receiving circuit that realize correct data transmission even when a failure occurs in some of virtual concatenation paths, because data is provided through only normally operating paths, and because only data from normally operating paths is multiplexed in restoring the data in original form.

Protection units provided in the present invention avoid an erroneous decision as to whether a path is failing. Detected failure is immediately reported to a counterpart transmission apparatus such that a smooth switching of active data paths is performed at a correct timing.

Other effects of the present invention include that a buffer-full status is reported to a transmitting side such that data will not be lost on the receiving side, that providing a plurality of storing units make writing and reading control simple, and that a manual operation of active path selection is enabled.

Further, the present invention is not limited to these embodiments, but various variations and modifications may be made without departing from the scope of the present invention.

The present application is based on Japanese priority application No. 2001-383726 filed on Dec. 17, 2001 with the Japanese Patent Office, the entire contents of which are hereby incorporated by reference.

What is claimed is:

1. A path control method of a system that transmits and receives data by-virtual concatenation, wherein data is assigned to a plurality of paths by a transmitting circuit of a first transmission apparatus located at a first edge of the plurality of the paths, the data is transmitted through a synchronous network, the data is received by a receiving circuit of a second transmission apparatus located at a second edge of the paths, and the received data is multiplexed such that the data is restored, comprising the steps of:
restoring the data using only data received through normally operating paths, when a failure is detected in a path by the receiving circuit, and
assigning data to only normally operating paths by the transmitting circuit based on a status of the failure that is supplied from the receiving circuit.

2. A receiving circuit of a system that transmits and receives data by virtual concatenation, wherein data is assigned to a plurality of paths by a transmitting circuit of a first transmission apparatus located at a first edge of the plurality of the paths, the data is transmitted through a synchronous network, the data is received by a receiving circuit of a second transmission apparatus located at a second edge of the paths, and the received data is multiplexed such that the data is restored, comprising:
a first failure detecting unit that detects a failure of any of the plurality of the paths from which data is received, and
a data restoration unit that multiplexes only data received from normally operating paths, excepting the detected failed path, and restores the data.

3. A transmitting circuit of a system that transmits and receives data by virtual concatenation, wherein data is assigned to a plurality of paths by a transmitting circuit of a first transmission apparatus located at a first edge of the plurality of the paths, the data is transmitted through a synchronous network, the data is received by a receiving circuit of a second transmission apparatus located at a second edge of the paths, and the received data is multiplexed such that the data is restored, comprising:
a second failure detecting unit that detects a status of the failed path detected by the receiving circuit, and
an allocation control unit that assigns data to only normally operating paths, excepting the failed path, based on the status of the failed path.

4. The receiving circuit as claimed in claim 2, further comprising a first protection unit that determines normally operating paths when detection results of the first failure detecting unit continue unchanged, data on the normally operating paths being multiplexed by the data restoring unit.

5. The transmitting circuit as claimed in claim 3, further comprising a second protection unit that determines normally operating paths when detection results of the second failure detecting unit continue unchanged, data being assigned to the normally operating paths by the allocation control unit.

6. The receiving circuit as claimed in claim 2, wherein the first failure detecting unit determines that a path is in failure when an error rate of the path exceeds a first threshold value.

7. The transmitting circuit as claimed in claim 3, wherein the second failure detecting unit determines that a path is in failure when an error rate of the path exceeds a second threshold value.

8. The receiving circuit as claimed in claim 6, further comprising a first setting up unit that sets up the first threshold value.

9. The transmitting circuit as claimed in claim 7, further comprising a second setting up unit that sets up the second threshold value.

10. The transmitting circuit as claimed in claim 3, further comprising a reporting unit that transmits identity information of paths to which data is assigned by the allocation control unit, the identity information being transmitted to the receiving circuit.

11. The receiving circuit as claimed in claim 2, wherein the first failure detecting units detects a failure of a path by receiving the identity information transmitted from the reporting unit.

12. The transmitting circuit as claimed in claim 10, further comprising a time difference setting up unit that provides a time difference between reporting the identity information from the reporting unit to the receiving circuit, and assigning data to normally operating paths by the allocation control unit.

13. The transmitting circuit as claimed in claim 3, further comprising:
a first storing unit that stores data to be transmitted, and
a supply halt reporting unit that directs suspension of data supply when the first storing unit is fully loaded.

14. The receiving circuit as claimed in claim 2, further comprising:
a plurality of second storing units that store data restored by the data restoring unit, and
a switching unit that switches a storing unit that stores the restored data from one of the second storing units to another of the second storing units when data vacancy is detected in the restored data.

15. The transmitting circuit as claimed in claim 10, wherein the identity information of paths to which data is assigned by the allocation control unit is provided from an external apparatus.
